(19) United States
(12) Patent Application Publication
(10) Pub. No.: US 2001/0013884 A1
(43) Pub. Date: Aug. 16, 2001

(54) INK JET CARTRIDGE REFILL SYSTEM, KIT, STATION, AND METHOD

(76) Inventors: RICHARD G. CRYSTAL, LOS ALTOS, CA (US); SVEN KARLSSON, SAN JOSE, CA (US); HERBERT D. VARGAS III, FREMONT, CA (US)

Correspondence Address: JACQUES M DULIN, HELLER EHRMAN WHITE & MCAULIFFE, 525 UNIVERSITY AVENUE, PALO ALTO, CA, 943011900

(21) Appl. No.: 08/967,301

(22) Filed: Nov. 1, 1997

Related U.S. Application Data
(63) Continuation-in-part of application No. 08/722,653, filed on Sep. 30, 1996, now abandoned.

(51) Int. Cl. B41J 2/175

(52) U.S. Cl. 347/85

(57) ABSTRACT

An ink refill system, ink refill station, ink refill kit, and method to replenish both pigment and/or dye-based inks in cartridges of ink jet printers, plotters, copiers, and fax machines. A number of embodiments are described. The principal embodiment is a refill kit characterized by a spring clip assembly removably mountable on a cartridge. The clip assembly has mounted upon it a member which is sealingly connectable to the vacuum relief valve port or bubble generator on the bottom of the ink jet cartridge, an internal channel of the clip assembly connecting the bubble generator port and sealing member to a receptacle which removably connects to a flexible ink refill bottle, which bottle is adapted to both inject ink into, and remove excess air from, the cartridge via the bubble generator port. A permanently mountable footplate embodiment of this system is also described. A initial fill and refill station for commercial operation is also disclosed providing for alternatingly connecting the bubble generator of the cartridge by means of a removable sealing member to a vacuum source and an external ink supply, controlled by a three-way valve.

### CROSS-REFERENCE TO RELATED APPLICATIONS

This application is a continuation in part of our pending U.S. application Ser. No. 08/722,653, filed Sep. 30, 1996 by us, entitled “AUXILIARY INK RESERVOIR AND FEED SYSTEM AND METHOD FOR INK JET CARTRIDGES”, the disclosure of which is hereby incorporated by reference. This application also applies to apparatus and methods of auxiliary feed of ink jet ink of the type disclosed in our two prior related provisional applications, U.S. Provisional Application Serial No. 60/016,919, filed May 6, 1996, and U.S. Provisional Application Serial No. 60/025,211 filed Aug. 23, 1996. The disclosure of each of these provisional applications is likewise incorporated by reference. By way of background, we also incorporate by reference the application of Crystal, Ser. No. 08/555,143, filed Nov. 13, 1995, entitled “INK COMPOSITIONS HAVING IMPROVED OPTICAL DENSITY CHARACTERISTICS”, which is now U.S. Pat. No. 5,662,734 issued Sep. 2, 1997.

### TECHNICAL FIELD

The invention relates to an ink refill system, ink refill station, ink refill kit, and method to replenish both pigment and/or dye-based inks in cartridges of ink jet printers, plotters, copiers, and fax machines. A variety of embodiments are shown, the principal embodiment of which is a refill kit characterized by a spring clip assembly removably mountable on a cartridge. The clip assembly has mounted upon it a member which is sealingly connectible to the vacuum relief valve port or bubble generator on the bottom of the ink jet cartridge, an internal channel of the clip assembly connecting the bubble generator port and sealing member to a receptacle which removably connects to a flexible ink refill bottle, which bottle is adapted to both inject ink into, and remove excess air from, the cartridge via the bubble generator port.

### BACKGROUND ART

Ink jet printers, plotters, copiers, and fax machines, particularly those for home or business or legal office use, have original ink cartridges of limited volumetric capacity, typically on the order of 40-50 ml. This provides printing approximately 800-1000 pages of text at 5% coverage. The typical ink jet printers, plotters, copiers or ink jet plain paper fax machine, such as the Hewlett-Packard series units, do not have systems for indicating remaining ink status or low ink conditions to prevent running out of ink in the midst of a printing job.

There are a number of proposals for addressing these operating limitations by means of continuous auxiliary reservoir ink feed systems and methods replenishing the original ink jet cartridge, or by discrete ink jet cartridge refill systems and methods. In a number of respects the art relating to continuous auxiliary reservoir ink feed systems and methods overlaps with and pertains to discrete cartridge refill systems and methods.

Proposals for auxiliary or reservoir feed systems typically involve drilling a hole in the top of the original printer tank, and inserting a tube into the tank. These are generally gravity fed, and may cause problems with the pressure differential between atmosphere and the inside of the original ink cartridge which is ordinarily under a slight but controlled negative pressure.

For example, Crystal, et al. (Graphic Utilities) U.S. Pat. No. 5,488,400 shows a top fill arrangement for refilling an ink cartridge. Ruder U.S. Pat. No. 4,967,207 (Hewlett-Packard) shows a top fill (needle) system separate from a top mounted vacuum port. The cartridge is moved to a service station that involves a valve that connects to the top fill needle and another valve connects to the vacuum port. A vacuum is drawn in the cartridge and it is batch filled with colorant through the separate fill needle. Erickson U.S. Pat. Nos. 5,367,328, 5,369,429, and 5,469,201 are three related patents directed to various aspects of a continuous top ink fill system which include an in line regulator for controlling the flow of ink. Cowger, et al. U.S. Pat. No. 5,010,354 is directed to a primary ink reservoir connected to a capillary volume element that is intermediate in pressure between the low pressure in the ink reservoir and external atmospheric pressure. As the ambient atmospheric pressure or temperature varies, the capillary element absorbs or discharges ink so that the primary reservoir pressure remains substantially constant so ink does not leak out the printhead orifices.

Such systems typically involve top feed, and either require special modifications of the printer cartridge by the consumer for retrofitting the auxiliary ink feed system, or a specially designed cartridge not of original equipment manufactured design to receive the external tank feed tube. A retrofit requirement is to drill a hole in the top of the tank, which can deposit debris in the tank. Such systems typically require skills and equipment that many consumers either do not have, or the systems require operations that consumers do not care to do.

Inks are complex compositions or mixtures. They are generally considered to be active, and must be maintained under controlled environmental conditions to maintain consistently high printing performance and print quality. By way of background in connection with certain types of problems of inks, including print rate, coverage, density and the like, see our copending application Ser. No. 08/555,143 filed Nov. 13, 1995, the disclosure of which is incorporated by reference herein to the extent need be for full and adequate disclosure of ink characteristics.

Modern ink jet printer cartridges operate under slight negative pressure, inter alia to prevent leakage of ink through the ink jet nozzles when the printer is not in use, and to assist in proper ink droplet formation during printing. There are a variety of devices incorporated in cartridge construction, including a lung-type spring-biased bellows system, and an inlet check valve which permits introduction of small bubbles of air as the ink volume within the generally sealed tank is reduced through usage. As the ink is used, the volume of ink within the reservoir is gradually reduced, and an increasingly negative pressure is created within the tank. If the pressure drops too low, then the cartridge will exhibit stall failure, in that the negative pressure within the tank will prevent feeding ink through the print droplet-forming ports or jet apertures. Accordingly, the check valve permits bleed-in of small bubbles of air to help maintain the pressure, hence the name vacuum relief valve, or vacuum check valve or the more colloquial name of “bubble generator.” In addition, the spring bellows expand slightly to compensate for loss of ink volume thus assisting in control of the pressure. The check valve and bellows within the cartridge are carefully balanced so that one can counteract the effect of the other to an extent such that the pressure curve flattens out and remains relatively constant as the volume of ink drops in the cartridge through usage.

Thus, any external ink replenishment system must not interfere with the overall balanced pressure characteristics of the original cartridge as each cartridge type is “tuned” to the particular printer speed, droplet size, ink characteristics such as viscosity, drying time, nature of ink (pigmented versus dye based inks ), etc. Further, any external feed system must be very simple and foolproof to retrofit, not involve special tools, and not be messy. Where there is a long air-filled feeder line from an external reservoir to the original cartridge, depending on the volume in the line, the pressure balance in the original tank can be adversely affected if that air were bled-in to the original tank in order to establish the ink feed from the auxiliary tank. That is, presently proposed external tank feed systems require priming the feed line from the external tank to the original tank. This can lead to spills, and poses a skill barrier to adoption by many consumers.

In addition, currently available external feed tank systems require a positive head in order to prevent backflow or siphoning out of the original tank to the auxiliary reservoir. Thus the auxiliary reservoirs need to be placed above the original tank, or they will require anti-siphon valves within the system. If the external tank is placed too high, the head may be too great and force too much fluid into the original tank. Likewise, if the tank is too low, pumping would be required or one could have a backflow siphoning effect potentially causing spillage of ink in the area of the external tank.

Some popular recent ink jet cartridge product designs have eliminated the OEM fill port and ball plug system. That is, some OEM manufacturers have, and others in the future may, fill the OEM cartridge through the bubble generator or vacuum relief valve by first evacuating the cartridge ink space, thus eliminating the need for an OEM fill port. This change in OEM cartridge design eliminates many of the previously proposed options for either continuous auxiliary ink feed systems or discrete cartridge refill systems and methods.

Accordingly, there is a need in the art for a simple cartridge refill system and method that avoids the problems of the art, is simple to use and retrofit, works well with original cartridge systems having no separate fill port, and which does not upset the integrity of the original cartridge and the printer to which it is tuned.

### DISCLOSURE OF THE INVENTION

A principal object and advantage of this invention is to provide an improved ink cartridge refill system and method, particularly suited for the ink cartridges of ink jet printers, plotters, copiers, and fax machines for business and personal applications which avoids the problems of the prior art.

It is among the objects and advantages of the invention to provide an improved ink cartridge refill system and method conveniently suitable to a cartridge which has no separate fill port in its originally manufactured (OEM) configuration, without requiring the formation of additional ports or holes, thus eliminating the risk of contamination of the cartridge with drilling debris or other foreign matter via the additional port, and simplifying the method of refill by avoiding the need to form and seal such a port while eliminating spilling from such a port during filling or use. A further object and advantage of the invention is to provide an improved ink cartridge refill system and method which makes use of the OEM vacuum relief valve, or “bubble generator” port existing in the cartridge in its OEM configuration as an ink refill path. The vacuum relief valves, check valves or bubble generators of the OEM cartridge are generally referred to herein as “valve” or “bubble generator”. Where an OEM cartridge includes also a bladder, springs or spring bladder, these elements are generally referred to herein as “bladder” or “lungs”.

A further object and advantage of the invention is to provide an improved ink cartridge refill system in kit form conveniently usable by a consumer without any special training or tools. A further object and advantage of the invention is to provide an improved ink cartridge refill system in kit form where any modifications to the OEM cartridge upon initial kit installation can be used for multiple refills of the cartridge.

A further object and advantage of the invention is to provide an improved ink cartridge refill system in kit form where no modifications to the OEM cartridge are required and the refilled cartridge is immediately ready for use in its original OEM configuration.

A further object and advantage of the invention is to provide an improved ink cartridge refill station to facilitate the filling or refilling of cartridges, both in an automated mode in an industrial application and in a manual mode in a business or consumer application.

In one refill system embodiment, provision for ink refill through the vacuum relief valve or bubble generator port or ports comprises a footplate which is mounted or adhered to the bottom or foot of the OEM cartridge covering the bubble generator port or ports. The footplate contains an internal conduit (or channel), one end of which terminates at and communicates with one or more apertures (or openings) in the footplate which, as installed, are cooperatively aligned with the port or ports (openings) of the cartridge which communicate with a vacuum relief valve or bubble generator, and the other end of which terminates in a connector mated to an ink refill tube or riser. The ink refill tube communicates with the ink supply, ink container or ink bottle of the refill system. Upon installation, the footplate is sealingly connected to the bottom of the cartridge so that the bubble generator port communicates through the internal conduit and connector to the ink refill tube, without leakage of air or ink at the mating surface of the footplate to the cartridge.

In the footplate embodiment, suitable for consumer refill kit use, the footplate is sufficiently thin in profile and narrow in lateral or rearward extent that, after refill of the cartridge, the footplate and connector do not interfere with the replacement of the cartridge in the printer or with operation of the cartridge during subsequent printing. During printing operation, the footplate continues to provide an adequately sized path initially for air in the line and thereafter for inks, to the vacuum relief valve or bubble generator during printing operation, so as to permit normal as-you-print-created vacuum regulation by the OEM cartridge. Thus, once it is mounted to or adhered on the cartridge, the footplate need not be removed. The footplate to feed tube connector preferably is positioned so that, like the rest of the footplate structure, it does not interfere with printer operation, and may remain in place following refill.

In the preferred footplate embodiment, the connecting and sealing of the footplate to the bottom of the cartridge is accomplished by means of a relatively heavy duty double-sided tape or adhesive gasket material (preferably pre-punched to match the shape of the footplate and bubble generator port or ports). The tape serves both to mount and seal the footplate in a manner that is easy and convenient to install without special tools. The tape may be used as a permanent mounting or may have a removable pressure sensitive bond with the cartridge surface. In addition the use of the tape eliminates the need for a separate sealing element, such as an O-ring.

In alternative embodiments, the footplate may be mounted by other means known in the art, such as by applied adhesives, clips, bonding or fasteners, and, if desirable, may be sealed to the cartridge by a separate means, such as by an O-ring, gasket or sealant.

In the embodiment as installed, the edge of the footplate opposite the ink jets of the OEM cartridge (the back edge of the cartridge, with reference to the ink jets being in the front) extends beyond the side wall of the cartridge slightly, and the connector projects upward from the footplate from this extended edge parallel to a back wall of the cartridge. The preferred connector comprises a thin tube bonded to the footplate in communication with the internal conduit and which is mated to the ink refill tube by insertion into the end of the proximal end of the refill tube. The ink refill tube is typically an approximately 1/16″ ID PVC (e.g., Tygon) tube. Insertion friction and elastic tension may serve to both fix and seal the connector to the ink refill tube, or alternatively the ink refill tubing may be glued to the connector. The ink refill tube may be any suitable length.

This embodiment allows the connector and ink refill tube to lie closely parallel to a side wall of the cartridge and to avoid interference with printer structure during subsequent printing operation, as the connector (and optionally, the ink refill tube) remains connected to the cartridge during printer operation following refill. The combination of the small lumen in the internal conduit, connector and ink refill tube, the ink viscosity, and the negative pressure of the operating cartridge maintained by the bubble generator, can prevent the ink dripping out of the connector or refill tube subsequent to refill. If the refill tube is to remain connected to the footplate during printing operation, it may be fitted at its distal end with a suitable vented plug following refill, which allows the bubble generator to communicate with the atmosphere so that negative pressure in the cartridge may be regulated by the bubble generator.

Preferably the edge of the footplate installed adjacent to the ink jets of the OEM cartridge has a margin which is matched in shape to as to provide an intrinsic installation alignment guide to the consumer. For example, the preferred embodiment has a left and a right “ear” projecting from this margin which fit into recesses on either side of the foot of a typical OEM ink jet cartridge. Any convenient geometric feature on the bottom and foot area of a particular OEM cartridge may be exploited in this manner to provide a “jigsaw puzzle” type of fit of an aftermarket refill system or kit footplate to a corresponding OEM cartridge to allow confident and reliable installation by the consumer.

Alternative embodiments may provide for the footplate to be sealingly connected in a temporary and easily removable manner to the cartridge. The mounting means may be by removable adhesive tape or coatings, or by clamps or other removable fastening means. As set forth below with respect to a refill station, a variety of different embodiments of the mounting and sealing means may be preferred where a considerable number of cartridges are to be refilled.

In this embodiment, the footplate is conveniently made of ABS plastic, but may be made of any suitable material. In this embodiment, the footplate is molded as a single layer. The internal conduit is molded as a groove or recess into the lower surface of the footplate, communicating with one or more openings on the upper surface of the footplate which match the position of the bubble generator port or ports of the OEM cartridges. The internal conduit is closed by means of a cover plate of similar material, which fit into molded grooves or shoulders on the lip of the conduit. The cover plate may be sealed and bonded by ultrasonic welding or other convenient means. The footplate of the this embodiment is on the order of 1/16 to ⅛ inch thick. The connector is a short thin tube of plastic which is inserted and bonded into a hole formed at the rear edge of the upper side of the footplate communicating with the internal conduit.

The dimensions of the footplate assembly and its components will be determined by the particular geometry of the OEM cartridge/printer combination, and the footplate and mounting means (double stick tape in the best mode of the footplate embodiment) are sized to fit within the space available underneath the OEM cartridge to permit normal printing operation with the footplate installed.

It may be seen that other embodiments of the footplate are possible which will produce a comparable functional structure. For example, the footplate may be formed from a distinct upper and lower plate, with the openings for the connector and for communication to the bubble generator being formed in the upper plate, and the internal conduit being formed in the lower plate, the two plates then being bonded and sealed together.

Likewise, in an alternative embodiment, the footplate can be formed from a single plate, with a openings for the bubble generator and the connector being formed to penetrate from the upper surface part way through the plate. These openings may be connected by drilling a hole within the plate from the edge of the plate intersecting both openings. The drill hole may then be plugged and sealed to form the closed internal conduit. In a variation of this embodiment, the connector may be inserted into the side edge of the footplate at the end of this drilled hole, eliminating the need for a separate connector opening.

It is clear that the particular structural detail of the footplate and connector assembly, the particular methods of sealing and mounting of the footplate, and the materials of construction may be chosen from those known in the art to suit convenience and economy of manufacture, and the particular geometry of the intended OEM cartridge/printer combination.

The preferred footplate embodiment described stresses simplicity of structure, simplicity of the sealing, bonding and installation of the footplate assembly, and a compact refill system structure suitable to typical OEM cartridge/printer clearances.

It should be understood that this invention is intended to be beneficially used in connection with a considerable variety of ink jet OEM cartridge geometry, installation clearances, and operating specifications, both as they are currently available in the industry and as they become available in the future. The particular structural details of the footplate assembly or equivalent refill ink delivery structure preferable to adapt this invention to a specific OEM cartridge/printer combination within the scope of this invention can be made by one of ordinary skill in the art without departing from the spirit thereof

It is likewise clear that where the refill system is not intended to remain connected to the cartridge after refill, as in the refill station described below, the geometry, structure, means of sealing and mounting, and materials of construction may be selected to suit the particular industrial application.

The system of this invention is ideally suited to a refill strategy whereby the refill system takes the form of a refill station suitable for sequential refill (or optionally initial fill) of multiple OEM ink jet cartridges. In an exemplary refill station embodiment of the invention, provision for ink refill through the vacuum relief valve or bubble generator port or ports comprises a sealing member which is placed surrounding the bubble generator port, which in turn is connected via a refill tube to an external ink supply. This exemplary embodiment comprises a unitary “fill station” assembly whereby the empty cartridge is inserted in a holder that both secures the cartridge and positions it to mate with the integral ink supply sealing member.

Optionally or additionally, the fill station may comprise or include an integral bulb pump or other air pressure source, such as a syringe, which is positioned by the holder to mate with the bladder pressure equalization port on the top of the cartridge. The cartridge is preferably held in an inverted position. The ink supply sealing member is connectible to the bubble generator opening of the cartridge by a sealing means, such as a sealing gasket, an O-ring or other resilient annular structure, and the mating force applied by the holder is sufficient to seal this connection against air or ink leakage. The ink supply sealing member is retracted from the cartridge once filled, and applied to the next cartridge in line. Although the sealing member may be functionally equivalent of the footplate of the refill system embodiments described above, it is not restricted in geometry by cartridge/printer design clearances, since it is removed from the cartridge immediately following refill, leaving the bubble generator exposed in its OEM configuration.

Alternative embodiments of the refill station are possible which are adapted to each of the methods of ink fill described in this application. In a first fill station embodiment, the ink supply sealing member is switchably connected to both a vacuum source and ink supply by a dual supply valve means, such as three way rotary valve. A vacuum can first be pulled on the cartridge via the bubble generator as air is drawn out of the bubble generator, the internal spring bladders (“lungs”) being inflated through the open-to-atmosphere pressure equalization port. Upon closing the vacuum and switching to the external ink supply, ink is drawn into the cartridge by the vacuum induced in the cartridge, during which the bladders collapses, expelling air out the equalization port.

In an alternative embodiment of the refill station, the bulb pump or air pressure source is mated to the bladder pressure equalization port prior to connecting the ink supply sealing member to the bubble generator. The bulb is compressed or the air pressure source opened, thereby pressurizing the bladders, forcing air out the bubble generator. Once the ink supply sealing member is connected to the bubble generator port, the bladder pressure is released and the collapse of the bladders draws ink into the cartridge, filling it.

The process or method aspects of this invention are suitable to both an initial fill and a refill of an ink jet cartridge. Thus this invention includes methods and kits for both initial fill and refill. In connection with a refill method embodiment, a refill kit may be provided to a consumer which comprises an ink feed sealing member, such as gasket or a footplate as described above, which is sealingly connectible around the bubble generator opening of the cartridge. The kit also comprises an ink supply bottle with an elastic, flexible exterior wall (squeeze bottle), such that squeezing and releasing the bottle wall creates alternating positive and negative pressure within the bottle and is capable of reversibly changing the internal volume of the bottle by a substantial fraction during each squeeze. The squeeze bottle preferably has a flexible tube or luer connected to it with one end opening into the bottle interior, the tube connecting to the gasket, footplate, or other sealing member at its opposite end. The internal volume of the footplate and tube should be small in proportion to the volume change occurring during a squeeze cycle of the bottle. This method comprises of the following steps:

(a) A gasket, footplate or other sealing member, connected to the ink supply squeeze bottle, is placed over and sealed surrounding the bubble generator port with the cartridge in an inverted position so that the bubble generator port opens upward, any residual ink within the cartridge being drawn away from the bubble generator by gravity;

(b) The ink supply squeeze bottle is positioned (inverted) so that the tube connection is down and any airspace within the bottle is at the end opposite the tube connection;

(c) The squeeze bottle is squeezed, forcing ink out of the bottle, into the tube and through the bubble generator into the cartridge, the ink thus injected into the cartridge coming to rest by gravity at the lower end of the cartridge opposite the bubble generator;

(d) The squeeze bottle is released, creating a suction which first withdraws the small volume of residual ink from the tube and then withdraws air from the airspace within the cartridge through the bubble generator port;

(e) Steps (c) and (d) are repeated in sequence alternately injecting ink and withdrawing air until the desired amount of ink has been injected; and

(f) The squeeze bottle is then removed (the gasket, footplate and tube may optionally be removed, or may be left on the cartridge).

Optionally, this embodiment can be modified to make use of a bulb suction pump, syringe or bellows by combining the following steps (c′) and (d′) performed simultaneously with steps (c) and (d) respectively.

(c′) The (previously compressed) bulb tip is inserted into the bladder air port, the bulb is then released, causing a suction which causes the bladders to collapse, and thus assisting in drawing ink into the cartridge; and

(d′) The bulb is then recompressed, creating a positive pressure which causes the bladders to re-inflate, assisting in the removal of air from the cartridge through the bubble generator.

The lungs or bladders of the cartridge are normally in a partly inflated state when the cartridge becomes empty. As a preliminary step, the bladders may be fully inflated (overinflated) by means of a bulb pump inserted in the air port of the bladders prior to placing the footplate over the bubble generator.

In an alternative method embodiment, a refill kit may be provided to a consumer which comprises an ink bottle which serves as a refill ink supply, a small flexible bulb or bellows (which serves as a positive and/or negative pressure source), and an ink feed sealing member, such as a gasket member or footplate as described above, which is sealingly connectible around the bubble generator opening of the cartridge. In this embodiment, the method comprises the following steps:

(a) The bulb tip is inserted in the air port of the spring bladders, air bag or lungs (“bladder”) of the cartridge located on the upper portion of the cartridge;

(b) The bulb is compressed, inflating the bladder to its full extent, and thereby forcing air out the bubble generator (The cartridge is preferably inverted during this procedure to prevent residual ink leakage);

(c) While the bladder remains inflated and extended due to overpressure provided by the manual bulb pump, the footplate or other sealing member (connected to the external ink supply) is placed over and sealed surrounding the bubble generator port; and

(d) Then the bulb is released and removed, the bladder is permitted to collapse, and the ink is drawn into the cartridge through the bubble generator. In this embodiment, it is the action of the spring bladder in creating a negative pressure within the cartridge that draws the ink into the cartridge through the bubble generator.

Optionally, two additional steps may be added in sequence while the external ink supply remains connected:

(e) The bulb is compressed and re-inserted into the bladder air port; and

(f) The bulb is released creating a suction which further collapses the bladders, drawing ink into the cartridge through the bubble generator.

Steps (a) through (d), or optionally (a) through (f), may be repeated until the desired level of ink fill is obtained.

In an alternative embodiment of the ink fill method, a commercial (factory or retail refill center) refill station may be provided that is adapted with multiple stations and operating speed for sequential filling of a number of cartridges. The refill station may include a means for securing the cartridge (hold downs), and a sealing member serving a function similar to the footplate described above, but switchably connected to both a vacuum source and ink supply. The method comprises the following steps:

(a) A sealing member (comprising a sealing means such as a gasket, an O-ring or other resilient annular structure), which is switchably connected to a vacuum source and an ink supply, is placed over and surrounding the bubble generator port;

(b) The vacuum source is switched open to connect to the sealing member and bubble generator opening, thereby creating a vacuum in the ink space of the cartridge by suction of air through the bubble generator, the internal spring bladders (“lungs”) being inflated during this step by air drawn through the open-to-atmosphere pressure equalization port of the cartridge (the cartridge is preferably inverted to an upside down position during this procedure to prevent residual ink leakage);

(c) The vacuum source is closed while the sealing member remains surrounding the bubble generator port;

(d) An ink supply valve is opened to connect to the sealing member and bubble generator port, the external ink supply being maintained at atmospheric pressure (or it may be under positive, driving pressure), and the pressure difference between the vacuum previously created in the cartridge and the ink supply thereby causes ink to be drawn into the cartridge; and

(e) The sealing member is retracted from the cartridge once filled, and the process repeated to the next cartridge in line.

This method embodiment may be automated or manual in operation depending on the industrial application It should be noted that the above described process is feasible with either the bubble generator facing upwards, or downward. In the event that the bubble generator is facing upwards (cartridge inverted), the process may be carried out in a number of evacuation/fill cycles, each cycle adding additional ink to the cartridge, since gravity prevents ink within the cartridge from covering the bubble generator in this inverted position.

In the event that the bubble generator is facing downward, the injected ink within the cartridge will pool covering the bubble generator. The process is still feasible, if the cartridge is filled to the desired level in one cycle. This orientation may be preferable in an industrial setting.

The current best mode embodiment of the invention for a consumer (home or office) refill kit uses a spring clip or spring clamp (“clip”) type mounting to join the ink supply sealing member to the bottom of the cartridge, rather than an adhesively mounted footplate-type sealing member described above. Alternative clamping means, such as a screw or ratchet clamp, may be used. The refill principle is essentially the same as with the adhesively mounted footplate refill kit embodiment, but the cartridge is held to the sealing member (e.g. a gasket) only temporarily during refill operation. Following refill, the cartridge is removed from the clip mounting assembly, and is replaced into the printer without any non-OEM attachments. This embodiment may be particularly advantageous for use with a present or future OEM cartridge design having close spacing tolerances as installed in the printer. This system works particularly well with OEM cartridges in which the air equalization ports have been eliminated or permanently sealed.

The clip is preferably a thermoplastic strip of an approximately “C” shape in cross section. The spring clip, when installed, partially encircles the cartridge, having an upper portion which covers the bubble generator, and optionally and preferably also covers the ink jets of the cartridge when the cartridge is inverted. The clip has a lower portion that secures the cartridge by clamping over and around the top of the cartridge, which in cartridges having an air equalization port, clips over but does not seal closed that port. The clip is sufficiently flexible to allow easy insertion/removal of the cartridge by hand, but has enough residual spring tension to securely hold and sealingly clamp the cartridge. The clip shape is adapted to the specific dimensions of an OEM cartridge to provide a secure, sealing fit (and preferably a snap lock) around the cartridge when it is fully inserted. The lower portion of the clip is preferably shaped as a stand to allow the clip with cartridge inserted to be set upon a flat surface such as a desk and stand securely without additional support. The cartridge, in this best mode embodiment, is preferably held in an inverted position with the bubble generator facing up.

The upper portion of the clip, in the area which is adjacent to the bubble generator when the cartridge is inserted, has a bore through the clip from outside to inside. The inside opening of the bore has a gasket or other sealing means (such as an O-ring) mounted surrounding this bore opening in a position which allows the gasket to mate to and around the bore opening of the bubble generator with an ink-tight fit when the cartridge is inserted into the clip.

Mounted on the outside opening of the bore is an ink bottle receptacle of cup-like shape. The cup portion of the receptacle is shaped to snugly receive the top and neck portion of an ink supply bottle. The receptacle has an axial connecting tube which communicates between the center of the inside of the cup and the bore through the clip. This tube extends into the cup of the receptacle to communicate with the top of the ink supply bottle, when inserted.

The receptacle is may be bonded or glued to the clip, or it may be formed integrally with the clip. The receptacle may also be mounted to the clip by means of a threaded base which screws into corresponding threads formed in the inner wall of the bore in the clip, with the axial channel opening through this threaded base into the bore. Alternatively, a threaded adapter with a central communicating bore may be fitted between the receptacle and the clip, if desired, to provide a suitable joining of receptacle to clip if it is desired to form the receptacle base of a different diameter than the bore in the clip. A sealing means is provided, either affixed to the cup or the ink supply bottle, to provide an ink-tight seal between the bottle and the receptacle. An example is a soft polymeric plug in the bottle mouth.

The refill kit may be made universal in that it is capable of refilling different models of cartridges which have a similar overall size and shape, but differ in the particular location of the bubble generator opening. This may be done by providing an elongated or slot-like opening in the sealing gasket between the bubble generator and clip, or a “Y” shaped bore or channel configuration in the footplate, so that the inner gasket or footplate opening(s) is (are) sealed and mated over an area of the cartridge surface covering two or more different OEM bubble generator opening locations.

The clip preferably also has an absorbent pad mounted on the inside of the upper portion of the clip, in the region coordinate with the cartridge ink jets (when the cartridge is inserted), to absorb any ink that may ooze from the jets during refilling operation. Alternatively as sealing gasket material may be used at this location to temporarily close the ink jet orifices. In the preferred embodiment, the pad is contained in a recess of the clip which fits over the ink jets when the cartridge is inserted in the clip, and which both serves to accurately position the cartridge relative to the ink supply bore, and serves to protect the ink jets from any abrasion during insertion and removal from the clip.

In the preferred embodiment, the ink supply bottle is a flexible plastic serum-type container known in the art, with an elastomeric diaphragm-type top closure. The elastomeric diaphragm is typically sealed to the top lip of the bottle by means of an aluminum ring, which is crimped or swaged in place to securely clamp the diaphragm to the bottle lip. The bottle is preferably translucent to allow the ink level to be seen. The bottle is sufficiently flexible to be deformed on squeezing, but resilient enough to spring back into shape readily upon release.

The axial tube of the receptacle terminates in an angular cut to form a sharp hollow needle-like projection, which projects upwardly in the center of the cup. As the ink supply bottle top and neck portion is inserted into the cup of the receptacle, the needle projection pierces the diaphragm closure of the ink bottle, providing both a communication into the interior of the ink supply bottle, and an ink tight seal of the elastomeric diaphragm material around the outer surface of the needle. The bottle preferably is a disposable bottle, containing a quantity of ink sufficient for at least a single refill of the cartridge. This preferred embodiment minimizes the leakage of ink from either the insertion/removal of the cartridge or the insertion/removal of the ink supply bottle.

The receptacle cup is preferably of flexible construction to allow it to expand slightly under the pressure of bottle neck insertion, and to clamp the top and neck area of the ink supply bottle as the bottle is inserted, providing a more secure seal and mounting of the bottle to the receptacle. The cup is preferably transparent, and may be molded of plastic material or other moderately rigid material, with the flexibility provided by forming on or more slots in the cup running from the lip of the cup down the sides towards the base, but terminating before the needle projection, to divide the cup wall into spring-like “petals”. The ink supply bottle preferably has a narrowed neck area between the somewhat wider bottle top closure and the bottle shoulder Correspondingly, the inner portion of the cup “petals” may have projecting ridge portions which snap-fit about this narrowed neck area as the bottle is inserted into the cup to provide more secure joinder of the ink supply bottle to the receptacle and clip assembly.

As supplied in kit form, the needle projection of the receptacle is preferably covered with a protective sheath, such as a soft plastic tube, which can be removed prior to insertion of the ink bottle into the receptacle.

It should be understood that other types of ink supply bottles and receptacles which provide a secure mounting and communication of the ink supply to the clip assembly may be used with a clip mounted refill embodiment, such as the funnel cap squeeze bottle or accordion bottle described above with respect to the footplate embodiments.

The method of operation of this refill kit embodiment is the same in principle as described above with respect to the footplate refill kit embodiment. The inverted cartridge is pushed into the clip assembly by hand until the clip snap-fits around the cartridge with the bubble generator opening clamped and sealingly mated to the gasket and bore in the clip, and the clip assembly is oriented to have the bubble generator and receptacle pointing upwards. The sheath is then removed from the needle projection of the receptacle. The top and neck to the ink supply bottle is inserted into the cup of the receptacle until the needle pierces the bottle diaphragm and the bottle neck snap-fits into the cup at full insertion. At this point there is direct, sealed communication from the bubble generator opening to the interior volume of the ink bottle via the clip bore, the receptacle tube and hollow needle projection.

With the bottom of the bottle pointing upwards, the bottle is then squeezed, injecting ink through axial tube and bore, through the bubble generator opening into the cartridge interior. This injection of ink causes the bladder to deflate and the ink to pool at the bottom of the cartridge, away from the bubble generator. After deflation of the bladder, the squeezing pressure on the ink bottle is then released, allowing the bottle walls to restore themselves outwardly, in turn drawing air out of the cartridge through the bubble generator, and into the ink bottle via the bore and channel. The squeeze and release steps are repeated until the cartridge is filled to the OEM fill level, or until the ink bottle is empty. The final release of the squeeze bottle leaves the cartridge under a slight vacuum or negative pressure, which prepares the cartridge for immediate use.

The bottle may then be removed from the receptacle and the cartridge is removed from the clip. Any residual drops of ink in the bubble generator opening region may be wiped away with a tissue, and the cartridge re-installed in the printer, ready for use.

It should be noted that the clip-type refill embodiment is also readily adaptable to be used for a fill/refill station, such as the refill station utilizing separate valve-selectable vacuum and ink supply sources as described herein.

It should also be noted the invention includes the alternative of using the ink jet ports themselves for refill. The refill method, footplates, clip assembly and refill kit/station alternative embodiments of the invention may be adapted to use the ink jets of the cartridge as ports for drawing/injecting refill ink into the cartridge, or for removing excess air from the cartridge during refill, or for both of these steps. The sealing member and mounting means of each embodiment may be adapted in shape and location to sealingly connect to the area of the cartridge surface containing the ink jet orifices (the mounting means will be removable, leaving the ink jets uncovered following refill).

The ink jets orifices alone may be used in this manner, or the ink jets may be used in conjunction with the bubble generator port, with one of these alternative orifices of the cartridge being used for ink supply and the other being used for excess air removal, either as a continuous process (simultaneous ink injection and air removal) or in sequence.

### BRIEF DESCRIPTION OF DRAWINGS

The invention is illustrated in the drawings in which:

FIG. 1 is an isometric view from the right side of a typical printer or plotter showing the mounting location of the cartridge (parked position) with respect to the printer track and track housing;

FIG. 2 is an isometric view showing a single-layer embodiment of a footplate assembly mounted to the cartridge;

FIG. 3 is a section view through the single-layer footplate assembly of FIG. 2 along line 3-3 in FIG. 2;

FIG. 4 is an exploded isometric of an alternative form of a single-layer embodiment of a footplate assembly showing how it is mounted to the bottom of the cartridge, shown inverted to illustrate the vacuum relief valve location;

FIG. 5 is an exploded isometric view of a two-layer footplate assembly embodiment;

FIG. 6 is a section view of the two-layer footplate assembly of FIG. 5 taken along line 6-6 in FIG. 5;

FIG. 7 is a plan view of a cover-plate embodiment of a footplate assembly;

FIG. 8 is an exploded section of the cover-plate footplate embodiment shown in FIG. 7 along line 7-7 in FIG. 7 showing the placement of the cover plate;

FIG. 9 is a schematic elevation view showing a fill/refill system or station for cartridges having spring bladders and not having a fill port, or in which the fill port plug is not removed or removable; in which a valve is used to switch between a vacuum source and an ink reservoir for initial fill or refill through the bubble generator;

FIG. 10 is a isometric view of an installation suitable for application of an ink refill method utilizing a squeeze bottle ink supply mounted on the bubble generator;

FIG. 11 is an isometric view of an alternative type accordion bellows bottle, showing in phantom a finger pull loop for restoring the bottle to its fully expanded condition.

FIGS. 12A and 12B are views of the clip assembly of the current best mode consumer refill kit embodiment, FIG. 12A being an exploded view of the assembly showing the clip in partial cross section, and FIG. 12B being an assembled elevation view.

FIGS. 13A and 13B are views of the ink supply bottle assembly of the clip-type refill kit embodiment shown in FIG. 12, FIG. 13A being an assembled elevation view, and FIG. 13B being an elevation view showing the diaphragm cap elements in exploded view.

FIGS. 14A through 14D are views in time sequence of the squeeze-and-release refill process steps using the clip-type refill kit embodiment shown in FIG. 12, FIG. 14A showing the cartridge being inserted into the clip, FIG. 14B showing the ink supply bottle inserted into clip assembly receptacle, FIG. 14C showing the ink supply bottle being squeezed to inject ink into cartridge, and FIG. 14D showing the cartridge being removed from the clip following refill.

### DETAILED DESCRIPTION OF BEST MODES FOR CARRYING OUT THE INVENTIONS

The following detailed description illustrates the invention by way of example, not by way of limitation of the principles of the invention. This description will clearly enable one skilled in the art to make and use the invention, and describes several embodiments, adaptations, variations, alternatives and uses of the invention, including what we presently believe is the best mode of carrying out the invention.

In this regard, the invention is illustrated in the several figures, and is of sufficient complexity that the many parts, interrelationships, and sub-combinations thereof simply cannot be clearly or meaningfully illustrated in a single patent-type drawing. Accordingly, several of the drawings show in schematic, or omit, parts that are not essential in that drawing to a description of a particular feature, aspect or principle of the invention being disclosed. Thus, the best mode embodiment of one feature may be shown in one drawing, and the best mode of another feature will be called out in another drawing.

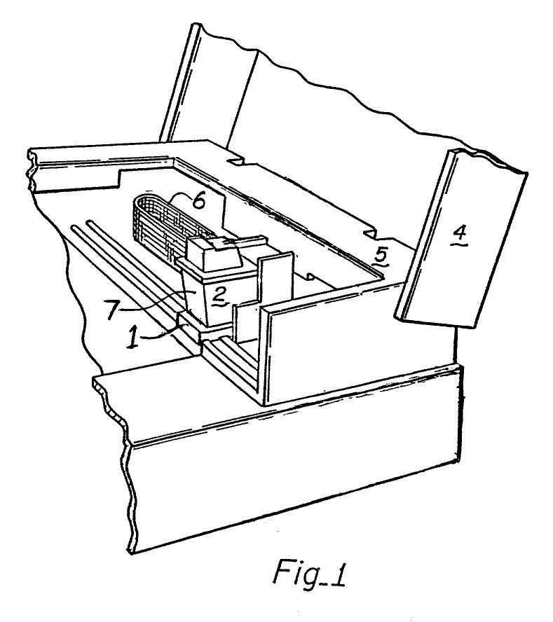

FIG. 1 shows an isometric view of portion of a typical ink jet printer, plotter, copier, or fax machine with a standard OEM cartridge 2 mounted on the carriage 1 within the printer track housing 5 with the printer top lid 4 open, the left to right motion of the cartridge being accommodated by the looped cartridge control ribbon 6. The cartridge is oriented with the back wall (the wall opposite the ink jets) 7 of a typical cartridge 2 facing towards the lower left.

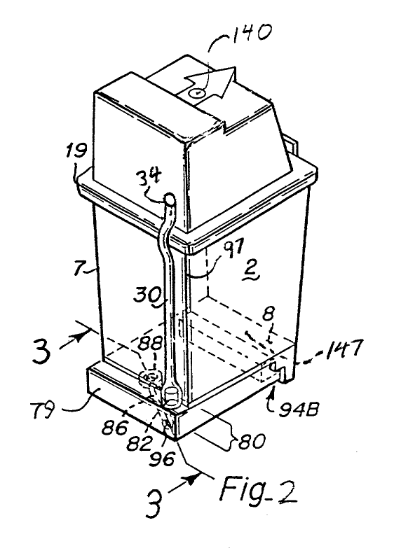

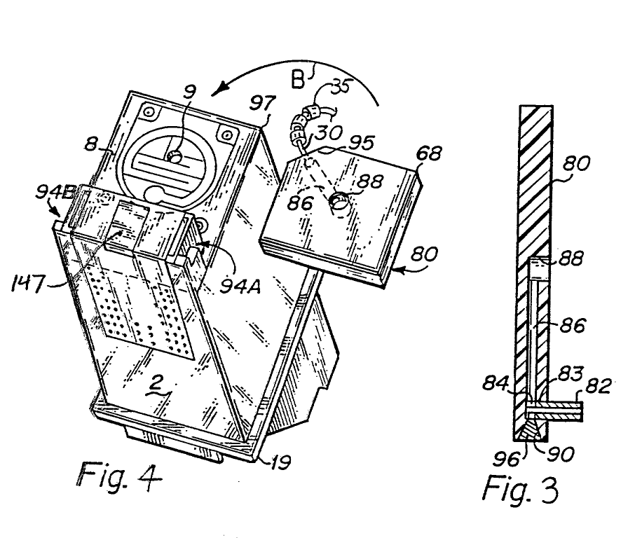

FIGS. 2 through 8 show several alternative footplate assemblies for footplate-type embodiments of the ink refill system of this invention. FIG. 2 is an isometric view which shows a single-layer footplate assembly 80 for a footplate embodiment of the ink refill system of this invention as installed on an ink jet cartridge 2. The cartridge 2 is in the same orientation as in FIG. 1, the cartridge orientation being described herein with reference to the ink jets 147 denoting the front end of the cartridge, independent of the placement of the cartridge in any particular printer or printing device. The footplate is located on the bottom 8 of cartridge and may be permanently or temporarily fastened by bonding, adhesives, or other suitable means. The ink refill tube 30 is led down the back 7 of the cartridge 2 to a male connector 82 (a union) which is inset in a hole in the upper side of footplate assembly 80 adjacent to the back edge 79 of the footplate assembly 80. The footplate assembly is shown here disconnected from a refill ink supply, which is connected to the distal end 34 of tube 30 during refill operation as described below in detail. The footplate installation configuration shown in FIG. 2 is also generally applicable to the alternative footplate embodiments described with reference to FIGS. 3 through 8.

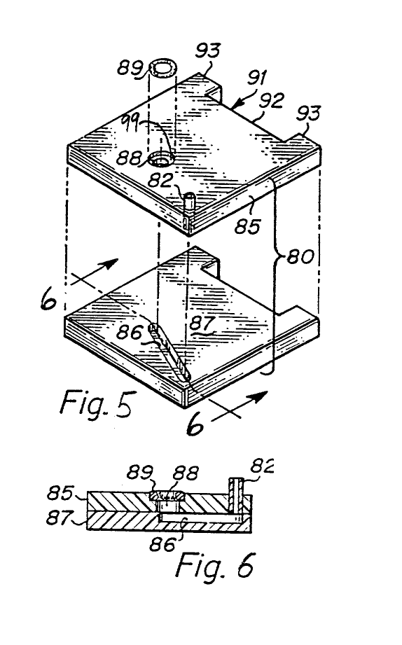

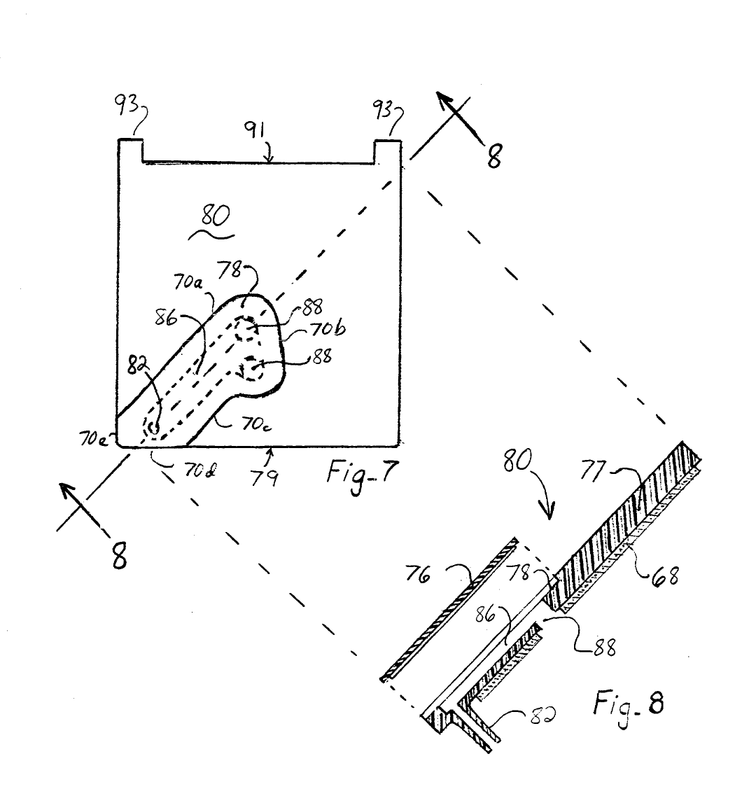

The footplate assembly may be constructed from a single layer of plastic or elastomeric material as shown in FIGS. 3 and 4, or from two layers as seen in FIGS. 5 and 6, or from a single primary layer and cover plate as seen in FIGS. 7 and 8. FIGS. 3 through 6 are shown in aforesaid application Ser. No. 08/722,653 while the preferred footplate-type embodiment of FIGS. 7 and 8 is an improvement. The footplate is an element of the system of this invention.

FIG. 4 is an isometric view which illustrates the location of the vacuum relief valve (bubble generator) 9 on the bottom 8 of the cartridge 2, and shows how the footplate assembly 80 is mounted to the bottom of the cartridge (the cartridge is shown inverted, with ink jets 147 facing upwards). The ink refill tube 30 is fed into a corner 95 of the footplate which connects with conduit or channel 86 and thence to transverse bore 88 which mates with the vacuum check valve 9 in the bottom 8 of the cartridge 2. This embodiment illustrates the use of double-sided tape 68 as a mounting and sealing means. The footplate assembly is illustrated with the double-sided tape 68 on the upward facing surface of the footplate which includes holes so as to expose bore 88. As noted by arrow B, the footplate is turned over 180° to mount the footplate on the bottom of the cartridge, aligning hole 88 with bubble generator opening 9.

The mounting location and alignment shown in FIG. 4 also characterizes the mounting of the other footplate embodiments described. An optional anti-kink coil wrap 35 is shown in FIG. 4, overlying the refill tube 30 adjacent to its junction with the footplate, which in this particular alternative footplate assembly is joined parallel to the plane of the footplate, rather than perpendicular to the footplate as in the other footplate embodiments described. This feature may be omitted. As may be best seen in FIG. 2, the tubing 30 can be led up along the corner 97 of the cartridge 2.

Turning to the details of the footplate construction, FIGS. 2 and 3 show a single layer embodiment of the footplate, in which channel 86 is formed by cross-drilling from an edge through entry 90. The tubular union connector 82 is inserted in hole 83, and the channel or conduit 86 terminates in transverse bore 88. The inner end of the connector 82 includes a notch or relieved portion 84 on one side which permits ink flow into tube 86. The entry 90 is then filled with an appropriate glue or plug 96, also shown in FIG. 2.

FIGS. 5 and 6 illustrate a two layer embodiment of the footplate assembly. The union connector 82 is inserted into upper layer 85 of the footplate assembly 80. As assembled, the connector leads to a channel 86 in the lower layer 87 of the footplate assembly. This channel is led diagonally to a bore 88 in the upper layer 85. The two layers are sealingly bonded together to form the completed assembly. The footplate bore 88 sealingly mates with the vacuum relief valve 9 in the bottom 8 of the cartridge 2 as best seen in FIG. 2. An o-ring 89 seated in recess 99 may be used to assist in the seal.

As noted, FIG. 6 is a section view taken along the line 6-6 of FIG. 5. Note also that the footplate forward end 91 has one or more notches 92 and/or ears 93A, B which mate with the corresponding relieved portions 94A, B in the foot of the cartridge as best seen in FIGS. 2 and 4. These ear and notch features may be incorporated in both single and multiple layer embodiments of the footplate assembly, and are features of the best footplate mode of the invention. These features assist in securing the footplate and serve to positively align the footplate assembly 80 with the bottom 8 of the cartridge 2, so as to maintain alignment of the fool plate bore 88 with the bubble generator opening 9. The ink is fed down the tube 30, through the connector 82, thence through the transverse diagonal channel 86, and enters through the bore 88 via vacuum relief valve 9 of the cartridge 2.

FIGS. 7 and 8 show the preferred footplate embodiment for a footplate-type refill kit, preferably integrally molded from a thermoplastic material. FIG. 7 is a plan view of the bottom of the footplate assembly 80. FIG. 8 is an exploded section view of the footplate assembly taken along line 8-8 shown in FIG. 7. This embodiment comprises a single primary layer 77, in which channel 86 is formed with an inset lip 78 surrounding the channel. The channel 86 connects the proximal end of the union connector 82 with one or more footplate bores 88. Depending on the bubble generator or vacuum relief valve configuration of the OEM cartridge, additional footplate bores 88 may be formed to align with each type and/or location of bubble generator or valve opening 9. Having multiple bores 88 permits the to be universal. As best seen in FIG. 8, the connector 82 and hole 88 are preferably formed or molded integrally with primary plate 77. Channel cover plate 76 is shown in exploded view. The channel cover plate is shaped to fit within inset lip 78 (following contour 70a-e in FIG. 7). Once assembled the cover plate 76 is bonded and sealed to the footplate 80 by any suitable means, such as ultrasonic welding or solvent glue bonding, thereby forming the lower boundary of channel 86. Double-sided tape 68 is punched or cut to fit the shape of the footplate upper surface, with an aligned hole or holes corresponding to the footplate bore(s) 88. The tape terminates clear of the connector 82, which in the mounted configuration will project beyond the back wall 7 of cartridge 2 as best seen in FIG. 2.

FIG. 9 shows a fill/refill station embodiment for initial OEM fill and subsequent aftermarket refilling of standard cartridges, such as the BP 51626, -29, -33M and Encad I, II, and III series, where such cartridges do not have a ball-plug fill hole on the top or it is determined that removal of the ball plug is not feasible or not desirable. While this is principally suitable for an industrial fill/refill operation, as it requires a vacuum source, enough vacuum can be provided by a manual pump such as a bulb pump, syringe or squeeze bottle, so that it can be part of an aftermarket consumer kit or refill station as well.

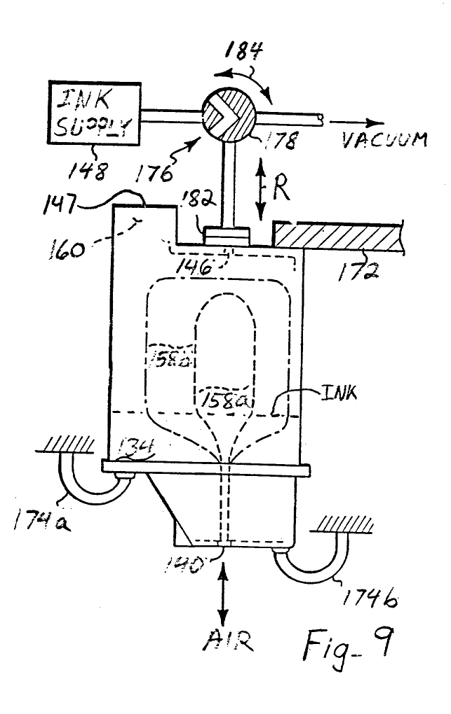

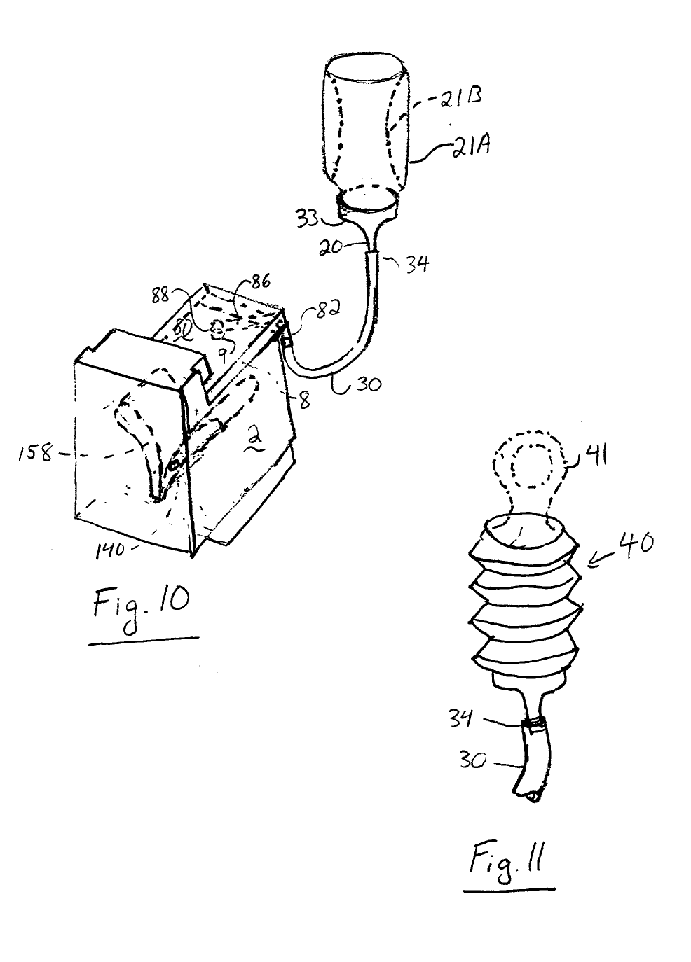

The cartridge 134 is clamped and retained between a base 172 and hold downs 174A and 174B in an inverted position. The base, hold downs and supply system 176 are shown in schematic. A seal member 182 is sealably engaged against the bottom of the cartridge around the bubble generator 146, moving as shown by arrow R. A three-way valve 178 is turned 184 so that it connects to a vacuum source 180. A vacuum is drawn in the ink space or interior space 160 of the cartridge 134 and the spring bladders 158 swell from the collapsed stage 158A to the enlarged state 158B by inspiration in of air through the bladder air port 140. Then the three-way valve 178 is rotated clockwise as shown by the arrow 184 to connect external ink supply 148 to the interior of the cartridge 160. The ink is drawn into the cartridge as the bladder 158 collapses and air is exhausted out the air port 140. The valve is closed (the position shown in FIG. 10) and the seal member 182 is removed from the bottom of the cartridge. The cartridge is removed from the hold downs and another cartridge is automatically shuttled in place for filling. This inverted orientation (with the bubble generator facing upwards) permits multiple alternative vacuum draw/ink flow cycles to fill the cartridge that is not possible of the cartridge is upright, due to pooling of ink within the partially filled cartridge covering the bubble generator. However, the operation is feasible in the bubble-generator-down orientation, provided the desired fill level is obtained in a single cycle. Alternatively, the refill station and its sealing member may be adapted to remove air and/or inject ink through the ink jets 147.

FIG. 10 is a isometric schematic view of an installation suitable for application of an ink refill method utilizing the tip of a squeeze bottle ink supply inserted into the ink supply tube connected to the bubble generator via footplate 80 (any of the embodiments of FIGS. 2-8). This embodiment and method utilize similar underlying principles as the refill station embodiment shown in FIG. 10 above, but is adapted to use as a consumer kit, The cartridge 2 is shown in the inverted position with the cartridge bottom 8 facing upwards. A footplate assembly 80 is sealingly mounted on the bottom 8 in the manner depicted in FIG. 2 whereby connector 82 communicates by means of channel 86 with footplate bore 88, which is aligned with bubble generator opening 9. The ink refill tube 30 is attached to connector 82 and is flexible enough to be bent upwards so that the distal end 34 faces upwards and is connected to a ink supply bottle cap funnel tip 20. The ink supply bottle cap 33 closes the opening of refill ink squeeze bottle 21. The squeeze bottle is depicted in the uncompressed state 21A and the compressed state 21B.

In refill operation, the lungs or bladders 158 of cartridge 2 are initially expanded since the cartridge is empty. The squeeze bottle 21 is initially uncompressed (21A) and full or partially full of ink, with any air space at the end opposite bottle cap 33 (upper or base end of bottle 21). Upon compression of the squeeze bottle (21B), ink is caused to flow through to refill tube and footplate assembly and is injected through the bubble generator opening into the cartridge. The volume displaced by the injected ink is compensated by expulsion of air from the lungs 158 through bladder pressure equalization port 140. The tip 20 of the bottle cap 33 remains in tube opening 34. Upon release of the squeeze bottle towards its uncompressed state (21A) the small amount of residual ink remaining in the footplate and refill tube is drawn back into the squeeze bottle and further decompression of the squeeze bottle draws air through the bubble generator opening and through the refill system into the squeeze bottle. Gravity keeps the air spaces in the cartridge 2 and the squeeze bottle 21 at the upper end of each respectively, so that repeated compression (21B) and decompression (21A) of the squeeze bottle results in continued injection of ink and withdrawal of air from the cartridge 2 until a desired level of refill is obtained. The cartridge and bottle is uprighted and the bottle removed. The configuration is now that of FIG. 2. The open end 34 of tube 30 may be left open (FIG. 2) or closed with a removable plug.

FIG. 11 shows an accordion bottle 40 which may be used in place of squeeze bottle 21 (FIG. 1). It is important that the bottle be capable of restoring itself to full length so that it draws air from the cartridge. That is, it should not be a collapsible, one-way accordion bottle, but one that restores itself to original dimension. The finger loop 41 is optional as shown in phantom, to assist in handling and positive restoration if needed. By pulling back on the loop (after an initial squeeze) a vacuum can be created in the cartridge which facilitates filling on the second squeeze/collapse of the accordion.

FIGS. 12, 13 and 14 show the current best mode embodiment of the invention for a refill kit, comprising a removable clip mounted sealing gasket rather than a footplate assembly. The refill principle and method is essentially the same as with the adhesively mounted footplate refill kit embodiment described above. However, following refill, the cartridge is replaced into the printer without any non-OEM attachments. FIGS. 12A and 12B are exploded and assembled views respectively of the clip assembly 100 of the refill kit. FIG. 12A is an exploded cross-sectional view of the clip assembly 100, showing the clip body 102 of an approximately “C” shaped strip form, having an upper recessed portion 102a, an upper mating portion 102b, a side portion 102c, and a lower portion 102d. The body of the clip may be formed by bending sheet material, or may be integrally molded or extruded. The upper mating portion 102b has a threaded bore 112 passing from outside to the inside of the clip. A apertured gasket 108 is fixed to the inside surface of the mating portion 102b, and has a hole or slot 114 aligned with the bore 112. An absorbent pad 110 is fixed to the inner surface of recessed portion 102a.

A receptacle 104 with a cup-like upper portion 121 is mounted to the outer surface of the upper mating portion 102b by means of a threaded adapter 106. The receptacle has a tube with an axial bore 115 which communicates through the body of the receptacle and terminates in an upwardly projecting hollow needle-like portion 116.

The bayonet flanges 113 on tube 115 engage corresponding internal threads in recess 120 of the adapter 106, so that tube 115 fits over and communicates with a corresponding tube 117 in threaded adapter 106. This tube 117 communicates axially through the body of the adapter to an opening in externally threaded base 119 of the adapter 106 which screws into the internally threaded bore 112 in the mating portion of the clip 102b. The clip assembly 100 is assembled by screwing the receptacle 104 to adapter 106 as shown by Arrow C and by screwing the adapter 106 to clip 102 as shown by Arrow C′.

It should be understood that the receptacle 104 may be mounted on clip 102 by a number of suitable means other than by the threaded adapter 106 shown. The adapter may be omitted and the receptacle directly thread-mounted to the clip, or the receptacle may be bonded or glued to the clip or mounted with separate fasteners or brackets. Alternatively, the receptacle may be integrally formed with the clip.

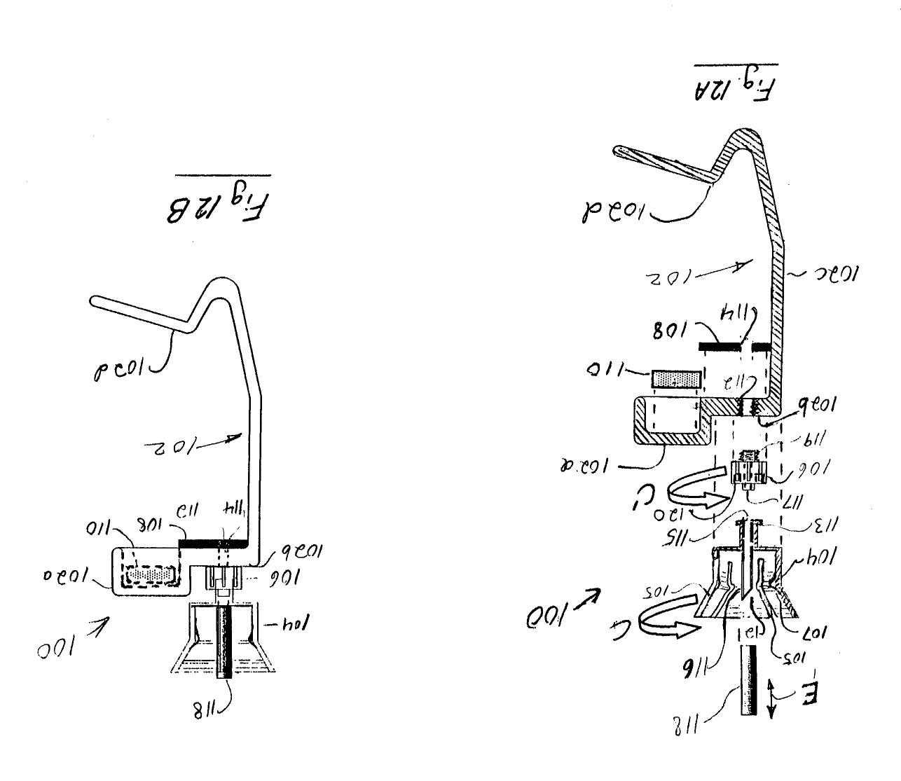

Thus a continuous passage is formed from the aperture 114 of gasket 108, through the bore 112 in the clip, then via the tube 117 of the adapter 106 through the axial tube 115 of the receptacle 104 through the hollow needle 116, opening into the cup 121 of receptacle 104. The needle 116 is sufficiently sharp to pierce a diaphragm type ink bottle cap (FIGS. 13a,b) to communicate with the interior of the bottle when the bottle cap is inserted into the receptacle cup 121. A removable sheath 118 preferably covers and protects the tip of needle 116 when the refill kit is not in use as shown by Arrow E.

The cup 121 is shaped to snugly fit the top and neck of an ink supply bottle (see FIGS. 13a,b). The inside of cup 121 preferably contains shoulder portions 107 which are shaped to fit the neck portion of the ink supply bottle. The cup 121 is subdivided longitudinally by a plurality of slots 105 which run down the sides of the cup 121 of the receptacle 104. These slots serve to provide a flexible construction petal-like spring finger to the cup the assist in accommodating the insertion of the ink bottle. The receptacle and cup may be molded of a transparent plastic material to allow the user to monitor ink bottle insertion visually.

FIGS. 13A and 13B are exploded and assembled views respectively of the ink supply bottle 21 and cap assembly 22 of the refill kit. The bottle cap assembly 22 is of a type known in the art, most commonly used for storage of injectable pharmaceuticals. The bottle has a broadened lip 25 and a narrowed neck region 24 between the lip 25 and the body of the bottle. The mouth 26 of the bottle 21 is closed by a diaphragm stopper 28 composed of an elastomeric material such as butyl rubber. The diaphragm stopper 28 and bottle lip 25 are surrounded by a cap ring or ferrule 29 composed of a malleable material such as aluminum. After filling with ink, the bottle is sealed by swaging cap ring 29 about the diaphragm 28 and bottle lip 25 to securely press and hold the diaphragm stopper 28 in the mouth 26 of the bottle. The shape of the lip 25 and neck region 24 of the bottle 21 is sized to match the cup 121 and shoulders 107 of receptacle 104 shown in FIG. 12A so as to provide a snap-fit as the bottle cap is inserted fully into the receptacle cup.

It should be understood that other types of ink supply bottles and receptacles which provide a secure mounting of the ink supply to the clip assembly may be used with a clip mounted refill embodiment, such as the funnel cap squeeze bottle, syringe or accordion bottle described above.

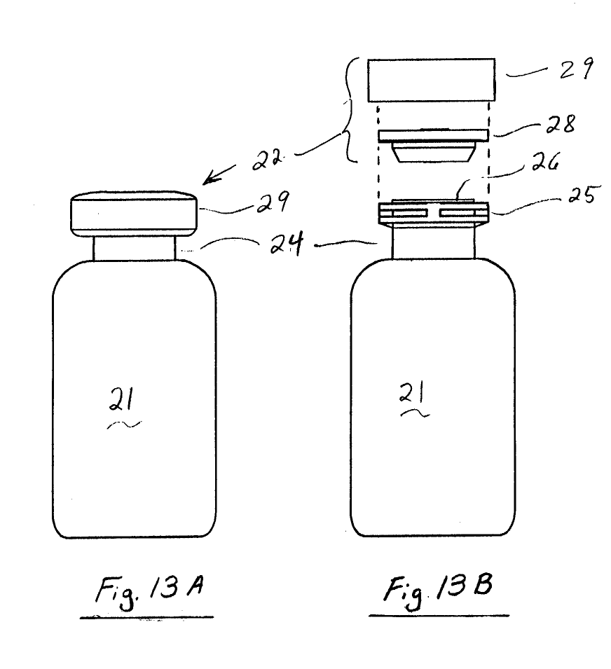

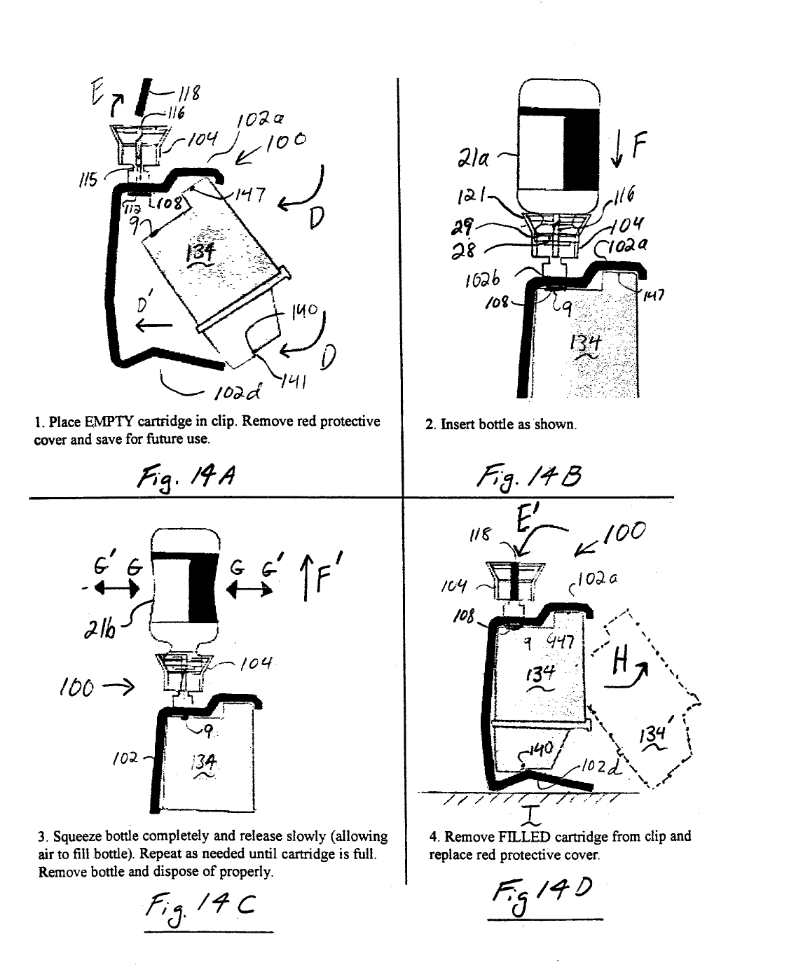

FIGS. 14A through 14D depict the overall assembly, operation and use of the refill kit. FIG. 14A shows the clip assembly 100 with receptacle 104 mounted upon it with an OEM cartridge 134 being inserted into the clip as shown by Arrows D. The ink jet portion 147 of the cartridge can be seen to be inserted first into the recessed portion 102a of the clip, with the lower portion of the cartridge adjacent to the bladder air port 140 being then pushed inward to rotate the cartridge into the clip. The recessed portion 102a serves to align the cartridge so that the bubble generator port 9 mates with the aperture in gasket 108 mounted around bore 112. As described in greater detail above with respect to FIG. 12, the tube 115 communicates from the bore 112 upwards through the needle 116.

As best shown in FIG. 14D, the lower portion of the clip 102d supports the bottom of the cartridge when it is fully inserted into the clip assembly 100. As an additional support feature, the OEM cartridge typically has a notch or step shoulder 141 adjacent to bladder air port 140, and the lower portion of the clip 102d may be shaped to take advantage of this notch, or some other cartridge feature, to obtain a snap-fit locking action as the cartridge is fully inserted in place within the clip. The lower portion 102d maintains sufficient residual spring pressure on the fully inserted cartridge to create a secure compressive force on the mating surfaces of the bubble generator 9 and the gasket 108. For user convenience, the lower portion 102d of the clip is also preferably shaped to serve as a stand so that the clip assembly 100 with cartridge and bottle attached may be set down securely in an upright position on table T without additional support.

Following insertion of the cartridge 134 into the clip assembly 100, sheath 118 is removed from needle 116 as shown by Arrow E in FIG. 14A. FIG. 14B shows the full ink supply bottle 21 (the undistorted bottle shape 21a is shown in FIG. 14B) inserted into the cup 121 of receptacle 104 in the direction shown by Arrow F, the bottle being inserted until the needle 116 pierces the diaphragm stopper 28 and the bottle cap 29 comes to rest at the bottom of cup 121.

As shown in FIG. 14C, ink is then injected into the cartridge via the bubble generator opening 9 by squeezing the sides of the ink supply bottle 21 inwardly (the inwardly deflected bottle shape 21b is shown in FIG. 14C) in the direction of Arrows G. After deflection, the bottle is released, and the walls spring back in the direction of Arrows G′ to the undistorted shape, drawing air out of the cartridge through the bubble generator opening. The squeeze/release cycle is repeated until the cartridge is refilled with ink to the desired level. Preferably, the volume of the ink supply bottle is matched to the cartridge OEM ink capacity so that the bottle is empty following refill of the cartridge to capacity. Following refill of the cartridge 134, the bottle is removed from the clip assembly 100, by pulling in the direction shown by Arrow F′.

Sheath 118 is replaced on needle 116 as shown by Arrow E′ in FIG. 14D following refill, and the cartridge 134 is removed from the clip assembly by reversing the step of FIG. 14a as shown by Arrows H and phantom view of the cartridge 134′. If a small amount of ink remains on the cartridge surface adjacent to the bubble generator 9 or the ink jets 147, this may be wiped away with a clean tissue, and the cartridge may then be re-installed in the printer for use. The absence of any non-OEM attachments on the re-installed cartridge may be advantageous for use with OEM cartridge designs having close spacing tolerances as installed in the printer, or other cartridge using device.

### INDUSTRIAL APPLICABILITY

The auxiliary ink system of this application will find wide applicability to a wide variety of printers, plotters, copiers, and plain paper faxes employing ink jet technology. Examples of these include: Hewlett-Packard: 900 series plain paper faxes, Desk Jet and Desk Jet Plus printers of the 500, 600, 1200C and 1600C series; Desk Writer and Desk Writer C series; plotters of the 650C and 750C series; and the ENCAD, Novajet I, II and III series. Without limitation, the system of this invention is applicable to the Hewlett-Packard cartridges of the following systems, 51625A; 51626A; 51629A, 51640C, Y, M; 51640A ( Black ); 51649A; 51650C, Y, M; 51633M; 51645A cartridges. The refill ink feed system of this invention may be easily adapted to cartridges, printers, plotters, copiers, and fax machines of other manufacturers, and for both pigment-type and dye-based inks.

It should be understood that various modifications within the scope of this invention can be made by one of ordinary skill in the art without departing from the spirit thereof. We therefore wish our invention to be defined by the scope of the appended claims as broadly as the prior art will permit, and in view of the specification if need be.

1. An ink fill/refill system for ink jet cartridges, which cartridge is of the type which includes means for compensating for vacuum generated therein during operation, such as vacuum relief valves, check valves or bubble generators, and optionally may include such means as bladders, springs, or lungs, and which includes in particular a bubble generator communicating with a opening in the exterior of the cartridge, comprising in operative combination:
(a) an external ink supply;
(b) means for connecting said ink supply to said bubble generator of said cartridge; and
(c) means for creating a pressure difference between said ink supply and the interior of said cartridge to provide ink flow into said cartridge in response to the pressure difference so created.

2. An ink fill/refill system as in claim 1 wherein said means for creating a pressure difference includes creating pressure differences alternating between an increase and a decrease or between a decrease and an increase in pressure between said ink supply and the interior of said cartridge.

3. An ink fill/refill system as in claim 2 wherein said means for connecting said ink supply comprises a footplate assembly having at least one internal conduit terminating in at least one aperture disposed to cooperatively align with said bubble generator of said cartridge to provide ink access to said cartridge through said bubble generator.

4. An ink fill/refill system as in claim 3 wherein said footplate assembly includes means for securing said footplate assembly to said cartridge, and wherein said footplate assembly is suitably limited in shape and size so that when so secured said footplate assembly does not interfere either with the mounting of said cartridge in said printer or with the travel of said cartridge during its movement during printer operation.

5. An ink fill/refill system as in claim 4 wherein said footplate assembly is secured to said cartridge by means of double-sided tape having at least one aperture therein which is coordinated with at least one aperture in said footplate assembly and which forms a seal around said opening to said bubble generator of said cartridge.

6. A refill kit for ink jet cartridges, which cartridge is of the type which includes means for compensating for vacuum generated therein during operation, such as vacuum relief valves, check valves or bubble generators, and optionally may include such means as bladders, springs, or lungs, and which includes in particular a bubble generator communicating with a opening in the exterior of the cartridge, comprising in operative combination:
(a) an refill ink supply container;
(b) means for sealingly connecting said container in fluid communication with said bubble generator of said cartridge; and
(c) means for alternatingly creating a higher and a lower pressure within said container than in the interior of said cartridge to provide refill ink inflow to said cartridge in response to the increased pressure and to provide excess air removal from said cartridge in response to the decreased pressure.

7. A refill kit as in claim 6, wherein:
(a) said container is a squeeze bottle having an exterior wall; and
(b) said means for alternatingly creating a higher and a lower pressure within said container is the capability of said exterior wall of said squeeze bottle to be depressed inward manually, resulting in decreasing bottle volume, and the capability of said exterior wall of said squeeze bottle to be released from said inward depression, resulting in increasing bottle volume.

8. A refill kit as in claim 7, wherein said means for sealingly connecting said container to said bubble generator of said cartridge includes a sealing gasket mounted on a spring clip, said gasket having at least one aperture disposed to cooperatively align with said bubble generator of said cartridge to provide ink access to said cartridge through said bubble generator.

9. A refill kit as in claim 7, wherein said means for sealingly connecting said container to said bubble generator of said cartridge includes a footplate assembly having at least one internal conduit terminating in at least one aperture disposed to cooperatively align with said bubble generator of said cartridge to provide ink access to said cartridge through said bubble generator.

10. An ink fill/refill station for ink jet cartridges , which cartridge is of the type which includes means for compensating for vacuum generated therein during operation, such as vacuum relief valves, check valves or bubble generators, and optionally may include such means as bladders, springs, or lungs, and which includes in particular a bubble generator communicating with a opening in the exterior of the cartridge, comprising in operative combination:
(a) means for retaining said cartridge during fill operation;
(b) means for inflating said bladder of said cartridge;
(c) means for sealingly engaging said bubble generator of said cartridge in fluid communication with an external ink supply; and
(d) means for releasing said inflation of said bladder while retaining said bubble generator sealed to permit filling said cartridge during deflation of said bladder to permit inflow of ink into the interior space of said cartridge.

11. An ink fill/refill station as in claim 10, wherein said means for inflating said bladder includes removing air from the interior of said cartridge by connecting said bubble generator of said cartridge to a vacuum source.

12. An ink fill/refill station as in claim 11, wherein said cartridge retaining means retains said cartridge in an inverted position.

13. An ink fill/refill station as in claim 11, wherein said means for releasing said inflation of said bladder while retaining said bubble generator sealed includes creating a pressure in said ink supply greater than the ambient pressure on said cartridge.

14. A method of filling or refilling ink jet cartridges, which cartridge is of the type which includes means for compensating for vacuum generated therein during operation, such as vacuum relief valves, check valves or bubble generators, and optionally may include such means as bladders, springs, or lungs, and which includes in particular a bubble generator communicating with a opening in the exterior of the cartridge, comprising in any operative sequence the steps of:
(a) retaining said cartridge during fill operation;
(b) inflating said bladder;
(c) sealingly engaging said bubble generator of said cartridge in fluid communication with an external ink supply; and
(d) deflating said bladder to draw ink from said ink supply through said bubble generator into the interior space of said cartridge.

15. A method of filling or refilling ink jet cartridges as in claim 14, in which said cartridge is retained in an inverted position.

16. A method of filling or refilling ink jet cartridges as in claim 14, wherein said bladder inflating step includes generating negative pressure in said interior space of said cartridge by vacuum draw through said bubble generator.

17. A method of filling or refilling ink jet cartridges, which cartridge is of the type which includes means for compensating for vacuum generated therein during operation, such as vacuum relief valves, check valves or bubble generators, and optionally may include such means as bladders, springs, or lungs, and which includes in particular a bubble generator communicating with a opening in the exterior of the cartridge, comprising in any operative sequence the steps of:
(a) retaining said cartridge during fill operation;
(b) maintaining said bladder in communication with the ambient atmosphere to provide for inflation or collapse of said bladder in response to decreases or increases of pressure within said cartridge;
(c) sealingly engaging said bubble generator of said cartridge in fluid communication with an ink supply container; and
(d) alternatingly creating a higher and a lower pressure within said container than in the interior of said cartridge to provide refill ink inflow to said cartridge in response to the increased pressure and to provide excess air removal from said cartridge in response to the decreased pressure.

18. A method of filling or refilling ink jet cartridges as in claim 17, in which said cartridge is retained in an inverted position.
